(19) United States
(12) Patent Application Publication
(10) Pub. No.: US 2020/0057740 A1
(43) Pub. Date: Feb. 20, 2020

(54) REMOTE LOGIN METHOD FOR SERVER SUBSYSTEM AND REMOTE LOGIN SYSTEM

(71) Applicants: INVENTEC (PUDONG) TECHNOLOGY CORPORATION, Shanghai City (CN); INVENTEC CORPORATION, Taipei City (TW)

(72) Inventor: Zhen GE, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/135,764

(22) Filed: Sep. 19, 2018

(30) Foreign Application Priority Data
Aug. 14, 2018 (CN) 201810922065.X

(51) Int. Cl. G06F 13/38; G06F 13/42; H04L 29/06; G06F 11/22

(52) U.S. Cl. CPC G06F 13/387; G06F 13/4282; H04L 67/42; H04L 69/08; G06F 2213/3852; H04L 63/168; G06F 2213/0002; G06F 2213/0042; G06F 11/221

(57) ABSTRACT

This invention provides a remote login method for a server subsystem comprising: sending a commands from a user terminal to a controller via a network; determining whether the command of the user terminal conforming to a preset format via the controller; executing a sequence port debug firmware when the commands of the user terminal conforming to the preset format; when the executed sequence port debug firmware is executed, enabling a data transmission channel between the controller and the server subsystem via the executed sequence port. In this way, the user terminal can log in the server subsystem remotely through the server controller to manage the server subsystem.

### CROSS-REFERENCE TO RELATED APPLICATIONS

This non-provisional application claims priority under 35 U.S.C. § 119(a) on Patent Application No(s). 201810922065.X filed in China on Aug. 14, 2018, the entire contents of which are hereby incorporated by reference.

### TECHNICAL FIELD

The disclosure relates to a remote login method for a server subsystem and a remote login system, more particularly to a remote login method for a server subsystem of a baseboard management controller and a remote login system.

### BACKGROUND

A main structure of a traditional server comprises a host and a baseboard management controller, wherein the main function of the baseboard management controller is monitoring the host. When a fault occurred on the baseboard management controller which needs to be accessed, the system manager usually checks the operation of the firmware of the baseboard management controller by accessing the serial port, and clarifies the reason of the fault. As the intelligent system becomes universal gradually, more and more manufactures integrate new intelligent subsystems in a server system, such as a smart network card, for the purpose of making improvements in both of management and fault allocation. As these reasons, it presently needs a method which can make the system manager remotely logs in the subsystem of the server system.

### SUMMARY

An embodiment of this disclosure relates to a remote login method for a server subsystem and a remote login system, which can make a system manager easily login and manage the server subsystem.

An embodiment of this disclosure relates to a remote login method for a server subsystem, comprising: sending a command from a user terminal to a controller via a network, wherein determining whether the command sent from the user terminal serial port debugging functions to a preset format by the controller. When the command from the user terminal conforms to the preset format, the controller performs a serial port debugging function. Therefore, when the serial port debugging function is performed, it is enabling a data transmission channel between the controller and the server subsystem; thus, the user terminal can log in the server subsystem.

An embodiment of this disclosure relates to a remote login system, comprising a controller and a server subsystem, wherein the controller comprises a command determination circuit, a first memory element and a first data transferring interface. The user terminal communicatively connects to the command determination circuit, wherein the command determination circuit determines whether the command sent from the user terminal conforms to the preset format. The first memory element saves the serial port debugging function. The server subsystem comprises a second data transferring interface, wherein the first data transferring interface of the controller electrically connects to the second data transferring interface of the server subsystem. Also, when the command from the user terminal conforms to the preset format, the controller performs the serial port debugging function for enabling the first data transferring interface and the second data transferring interface; hence, the user terminal can log in the server subsystem.

If the command conforms to the preset format, it comprises a preset claiming parameter.

The communications protocol of the network is a secure shell protocol (SSH).

The controller is a baseboard management controller.

The first data transferring interface and the second data transferring interface are the universal asynchronous receivers/transmitters (UART).

An embodiment of this disclosure relates to a remote login method for a server subsystem and a remote login system, at least including the following advantages. (1) Easy to be carried out in practice: it only needs cables to connect the second data transferring interface of the server subsystem to the first data transferring interface of the baseboard management controller; hence, any change to the hardware of the server is needless. (2) Easy to be operated: the user terminal can log in the server subsystem by entering a single command to further manage the server subsystem. (3) Privacy and security assurances: the transmitting data is encrypted since the command sent from the user terminal to the baseboard management controller via the network with the secure shell protocol (SSH). Furthermore, the server subsystem includes another security mechanism since the command sent from the user terminal needs to comprise the preset claiming parameter for logging in the server subsystem.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a structure diagram for an embodiment of the remote login system of this present disclosure.

FIG. 2 is a flowchart of the remote login method for an embodiment of a server subsystem of this present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

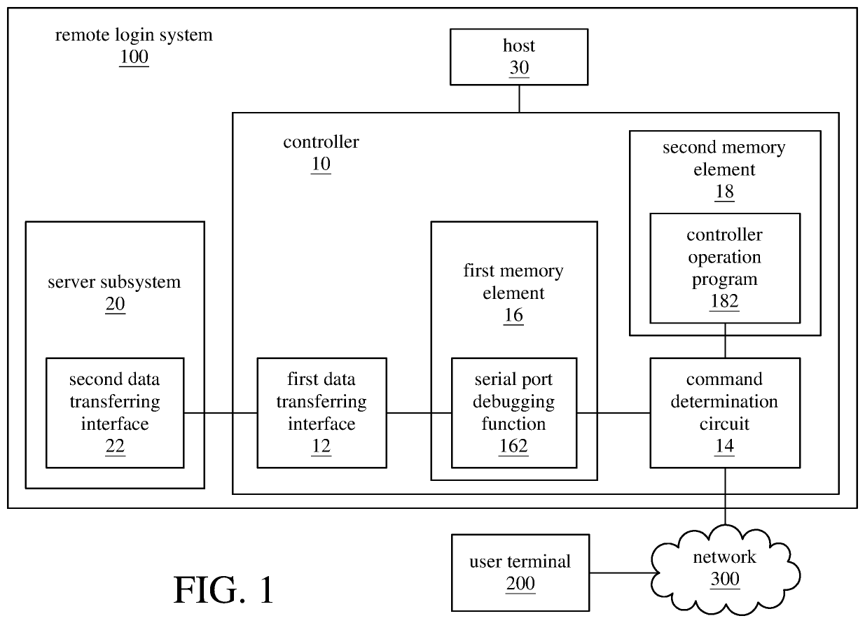

FIG. 1 is a structure diagram for the remote login system, which is an embodiment for this present disclosure. As FIG. 1 shows, the remote login system 100 supplies at least one user terminal 200 logs in remotely via the network 300, wherein the user terminal 200 can be a personal computer, a smart mobile, a notebook or a tablet. The remote login system 100 comprises a controller 10, a server subsystem 20 and a host 30, wherein the controller 10 electrically connects to the server subsystem 20 and the host 30. In this embodiment, the controller 10 is a baseboard management controller; in addition, in other embodiments, the controller 10 can be a complex programmable logic device (CPLD) or a field programmable gate array (FPGA) alternatively. The server subsystem 20 can be a smart network card or other smart device. The controller 10 comprises a first data transferring interface 12, a command determination circuit 14, a first memory element 16 and a second memory element 18. The command determination circuit 14 electrically connects to the first memory element 16 and the second memory element 18, wherein the first memory element 16 electrically connects to the first data transferring interface 12. Additionally, the first memory element 16 and the second memory element 18 are non-volatile memories; for example, they can be a Programmable Read-only Memory (PROM), an Electrically-alterable Read-only Memory (EAROM), an Erasable Programmable Read-only Memory (EPROM), an Electrically-erasable Programmable Read-only Memory (EEPROM) or a Flash. The first memory element 16 is used for saving the serial port debugging function 162 (for example, a minicon) adapted to enable the first data transferring interface 12, and the second memory element 18 is used for saving the controller operation program 182 (for example, a bash) for the controller 10. In this embodiment, the first data transferring interface 12 is an universal asynchronous receiver/transmitter (UART); moreover, in other embodiments, the first data transferring interface 12 may be a RS-232-C, a RS-422, a RS485 or a USB.

As FIG. 1 shows, the user terminal 200 can communicatively connect to the command determination circuit 14 of the controller 10 via the network 300. In this embodiment, the communications protocol of the network 300 is the secure shell protocol (SSH), wherein the SSH is an encrypted internet communication protocol which can supply a safe communication environment for the network service in a risky network. Because the SSH connects the users to the servers by building a secure channel in the network, people often execute the commands remotely by the SSH. The user terminal 200 can send the command to the controller 10 via the network 300, and the command determination circuit 14 of the controller 10 determines whether the command sent from the user terminal 200 conforms to a preset format. In this embodiment, the command includes one or a plurality of preset claiming parameters when the command from the user terminal 200 conforms to the preset format, wherein the preset claiming parameter can be an employee's number or an employee's ID. A server subsystem 20 comprises a second data transferring interface 22, and the second data transferring interface 22 of the server subsystem 20 electrically connects to the first data transferring interface 12 of the controller 10. In this embodiment, the second data transferring interface 22 of the server subsystem 20 is the universal asynchronous receiver/transmitter (UART); in addition, in other embodiments, the second data transferring interface 22 also can be a RS-232-C, a RS-422, a RS485 or a USB.

As FIG. 1 shows, when the command sent from the user terminal 200 comprises one or a plurality of preset claiming parameters, the controller 10 performs the serial port debugging function 162 to enable the first data transferring interface 12 of the controller 10 and the second data transferring interface 22 of the server subsystem 20; thus, the data transmission channel between the controller 10 and the server subsystem 20 can be enabled, and the command can be sent from the controller 10 to the server subsystem 20. As these reasons, the remote user terminal 200 can log in the server subsystem 20 for managing the firmware of the server subsystem 20. On the contrary, if the command determination circuit 12 determines the command sent from the user terminal 200 does not conform to the preset format, the user terminal 200 directly logs in the controller operation program of the controller 10.

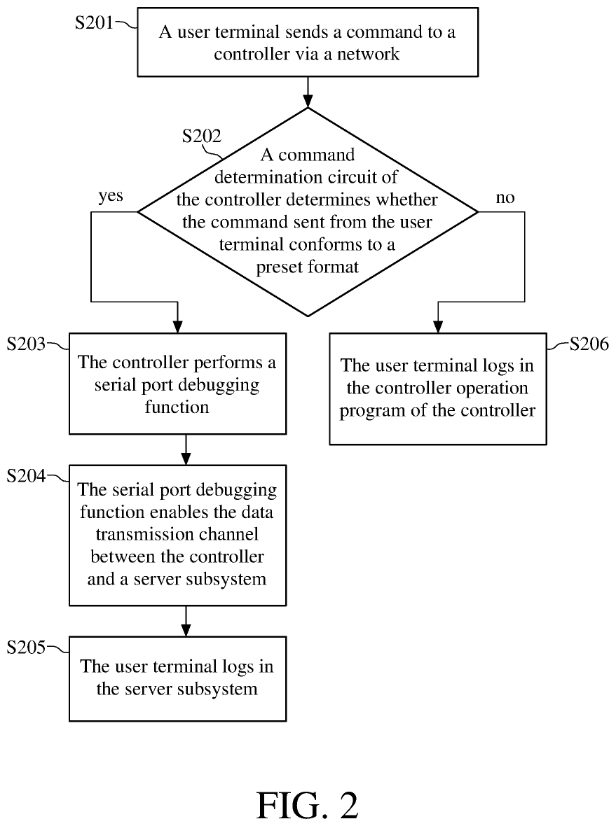

FIG. 2 shows the flowchart of the first embodiment of the remote login method for the server subsystem. For detailed description, as FIG. 2 shows, the remote login method for the server subsystem includes the following steps. In the step S201, the user terminal 200 sends the command to the command determination circuit 14 of the controller 10 via the network 300. In this embodiment, the communications protocol of the network 300 is the secure shell protocol (SSH). In the step S202, the command determination circuit 14 of the controller 10 is used for determining whether the command sent from the user terminal 200 conforms to the preset format. In addition, if the command sent from the user terminal 200 conforms to the preset format, the step S203 is performed; on the contrary, if the command sent from the user terminal 200 does not conform to the preset format, the step S206 is performed. In this embodiment, the command conforms to the preset format when the command includes one or a plurality of preset claiming parameters, wherein the preset claiming parameter can be an employee's number or an employee's ID. In the step S203, when the command sent from the user terminal 200 conforms to the preset format, the command determination circuit 14 of the controller 10 performs the serial port debugging function 162 saved in the first memory element 16 beforehand. In the step S204, when the serial port debugging function 162 is performed by the command determination circuit 14, the serial port debugging function 162 enables the data transmission channel between the controller 10 and the server subsystem 20. In the step S205, when the data transmission channel between the controller 10 and the server subsystem 20 is enabled, the user terminal 200 can log in the server subsystem 20 for managing the firmware of the server subsystem 20.

Furthermore, in the step S206, instead of logging in the server subsystem 20 for managing the firmware of the server subsystem 20, the user terminal 200 can only log in the controller operation program saved beforehand in the second memory element 18 of the controller 10.

An embodiment for this disclosure relates to the remote login method for the server subsystem and the remote login system, at least including the following advantages. (1) Easy to be carried out in practice: it only needs cables to connect the second data transferring interface of the server subsystem to the first data transferring interface of the baseboard management controller. (2) Easy to be operated: the user terminal can log in the server subsystem remotely by entering a single command to further manage the server subsystem. (3) Privacy and security assurances: the transmitting data is encrypted since the command sent from the user terminal to the baseboard management controller via the network with the secure shell protocol (SSH). Furthermore, the server subsystem includes another security mechanism since the command sent from the user terminal needs to comprise the preset claiming parameter for logging in the server subsystem, so.

The embodiments depicted above and the appended drawings are exemplary and are not intended to be exhaustive or to limit the scope of the present disclosure to the precise forms disclosed. Many modifications and variations are possible in view of the above teachings.

1. A remote login method for a server subsystem disposed in a remote login system, the remote login method comprising:
sending a command from a user terminal to a controller via a network;
determining whether the command sent from the user terminal conforms to a preset format by the controller;
performing a serial port debugging function stored in a first memory element of the controller when the command sent from the user terminal conforms to the preset format;
enabling a data transmission channel between the controller and the server subsystem when the serial port debugging function is performed, for the user terminal to log in the server subsystem.

2. The remote login method for server subsystem according to claim 1, wherein the user terminal communicatively connects to a command determination circuit of the controller via the network, with the command determination circuit determining whether the command sent from the user terminal conforms to the preset format.

3. The remote login method for server subsystem according to claim 2, wherein the command comprises a preset claiming parameter when the command sent from the user terminal conforms to the preset format.

4. The remote login method for server subsystem according to claim 1, wherein the user terminal logs in a controller operation program of the controller when the command sent from the user terminal does not conform to the preset format.

5. The remote login method for server subsystem according to claim 1, wherein the controller is a baseboard management controller.

6. The remote login system, a user terminal communicatively connects to the remote login system via a network, the remote login system comprises:
a controller comprising:
a command determination circuit, with the user terminal communicatively connecting to the command determination circuit via the network, wherein the command determination circuit determines whether a command sent from the user terminal conforms to a preset format;
a first memory element electrically connecting to the command determination circuit and saving a serial port debugging function; and
a first data transferring interface, electrically connecting to the first memory element; and
a server subsystem comprising a second data transferring interface, with the first data transferring interface of the controller electrically connecting to the second data transferring interface of the server subsystem;
wherein the command determination circuit performs the serial port debugging function for enabling the first data transferring interface and the second data transferring interface when the command sent from the user terminal conforms to the preset format for the user terminal to log in the server subsystem.

7. The remote login system according to claim 6, wherein when the command sent from the user terminal conforms to the preset format, the command comprises a preset claiming parameter.

8. The remote login system according to claim 6, wherein the communications protocol of the network is a secure shell protocol.

9. The remote login system according to claim 6, wherein the controller is a baseboard management controller.

10. The remote login system according to claim 6, wherein the first data transferring interface and the second data transferring interface are universal asynchronous receivers/transmitters.

11. The remote login system according to claim 6, wherein the controller comprises a second memory element the command determination circuit electrically connects to the second memory element saving a controller operation program and the user terminal logs in the controller operation program of the controller when the command sent from the user terminal does not conform to the preset format.
